(19) United States
(12) Patent Application Publication
(10) Pub. No.: US 2019/0273386 A1
(43) Pub. Date: Sep. 5, 2019

(54) INFRARED INTELLIGENT CONTROL WIRELESS CHARGING BRACKET

(71) Applicant: DONGGUAN DBK ENERGY TECHNOLOGY CO. LTD, Dongguan (CN)

(72) Inventor: Jinhui ZENG, Dongguan (CN)

(21) Appl. No.: 16/344,353

(22) PCT Filed: Nov. 23, 2018
(86) PCT No.: PCT/CN2018/117179

§ 371 Date: Apr. 23, 2019

(30) Foreign Application Priority Data
Dec. 29, 2017 (CN) 201721892686.5

(51) Int. Cl. H02J 7/02; H04M 1/04; H02J 7/00

(52) U.S. Cl. CPC H02J 7/025; H02J 7/0044; H04M 1/04

(57) ABSTRACT

Disclosed is an infrared intelligent control wireless charging bracket, including a housing, the inside of the housing defines a cavity, each side of the upper end of the housing is defined with a clamping arm for clamping a mobile phone, one is defined with an infrared emitting module, the other is defined with an infrared receiving module at a corresponding position thereon, the lower end of the housing is defined with a supporting member for supporting the mobile phone, a second baffle plate is defined on the upper portion of the supporting member, a gap for placing the mobile phone is defined between the second baffle plate and the front panel, the cavity of the housing is defined with a clamping mechanism module, a wireless charging module, and a main controller, a touch switch is defined on the lower left side of the front panel of the housing.

### FIELD

The present disclosure relates to a mobile phone bracket, and more particularly relates to an infrared intelligent control wireless charging bracket.

### BACKGROUND

Currently, mobile phones have bigger screen sizes, making them more difficult to use with one hand. During using the mobile phone, users will feel that wrists are uncomfortable if the mobile phone is held by their hands, especially when a long time is lasted. So, it is difficult for user to maintain a stable posture all the time, leading to swerves of the screen of the mobile phone, which would affect vision and make user dizzy. Additionally, the mobile phone consumes power quickly while watching videos or playing games, and needs to be charged in time. The most common way is charging the mobile phone with a charging cable. This way is limited by the length of the charging cable, so that the mobile phone can only be within a certain range around the power supply, which causes inconvenience to the use of the mobile phone.

A common bracket for the mobile phone is mechanical. If the user needs to take out the mobile phone during the charging or place the mobile phone on the bracket, it is necessary to manually push the bracket to place and remove the mobile phone, which is inconvenient for users in some specific scenarios. Therefore, how to optimize the user experience is a technical problem that needs to be solved in the industry.

### SUMMARY

It is one objective of the present disclosure to provide a wireless charging bracket with intelligent control and automatic clamping function.

The wireless charging bracket makes it possible to use with one hand. When the mobile phone needs to be charged, users may put the mobile phone on the bracket, then the clamping arms of the bracket will automatically retract and clamp the mobile phone to realize charging. When the charging is no longer needed, users may touch the touch switch slightly, the clamping arms of the bracket will automatically open, then users can easily remove the mobile phone. By providing the wireless charging function additionally, a better intelligent experience can be provided to the consumers.

In order to solve problems existed in the prior art, the present disclosure provides an infrared intelligent control wireless charging bracket.

For realizing the above aim, the technical solution provided by the present disclosure is as follows.

An infrared intelligent control wireless charging bracket includes a housing. The housing is provided with a front panel and a rear panel. The inside of the housing defines a cavity. Each side of the upper end of the housing is provided with a clamping arm for clamping a phone. One clamping arm is provided with an infrared emitting module, and the other clamping arm is provided with an infrared receiving module at a corresponding position thereon. The lower end of the housing is provided with a supporting member for supporting the phone, and a second baffle plate is defined on the upper portion of the supporting member. A gap is provided between the second baffle plate and the front panel, and the gap is configured to place the mobile phone. The front panel is a planar structure. A touch switch is provided on the lower left side of the front panel of the housing. The cavity of the housing is provided with a clamping mechanism module, a wireless charging module, and a main controller, the main controller is electrically connected with the clamping mechanism module, the wireless charging module, the infrared emitting module, the infrared receiving module and the touch switch, respectively.

The clamping arm includes a bottom plate and a block connected to one end of the bottom plate away from the housing. The inner side of the block is provided with a first baffle plate. A gap is provided between the first baffle plate and the bottom plate, and the gap is configured to place the mobile phone. The other end of the bottom plate is located in the cavity of the housing, and is connected with a compression spring or an elastic member.

The clamping mechanism module is configured to control opening and retraction of the clamping arm.

The wireless charging module is configured to charge the phone.

The main controller is configured to control and manage the whole system.

Specifically, the infrared emitting module is disposed inside the block of the left clamping arm, and the infrared receiving module is disposed inside the block of the right clamping arm. The infrared emitting module is located corresponding to the infrared receiving module.

The infrared emitting module is configured to emit an infrared signal, and the infrared receiving module is configured to receive the infrared signal emitted from the infrared emitting module. The infrared emitting module and the infrared receiving module cooperate with each other.

The touch switch is configured to control the opening and the retraction of the clamping arm via the clamping mechanism module.

In accordance with the present disclosure, the infrared emitting module and the infrared receiving module are used to detect the mobile phone. When the user places the mobile phone on the bracket, the clamping arms automatically retract to clamp the mobile phone, and when the user touches the touch switch, the clamping arms automatically open to allow the mobile phone to be taken out, which is convenient to the user.

### BRIEF DESCRIPTION OF THE DRAWINGS

The specific embodiments of the present disclosure are further described in detail with reference to the accompanying drawings and the embodiments.

FIG. 1 is an illustration of the clamping arm in a retraction status according to one exemplary embodiment;

FIG. 2 is an illustration of the clamping arm in an opening status according to one exemplary embodiment;

FIG. 3 is an electrical schematic diagram of the present disclosure.

### DETAILED DESCRIPTION OF THE EMBODIMENTS

For better understanding of problems solved, solutions adopted and effects achieved according to the present disclosure, the specific embodiments of the present disclosure are further described with reference to the accompanying drawings and the embodiments.

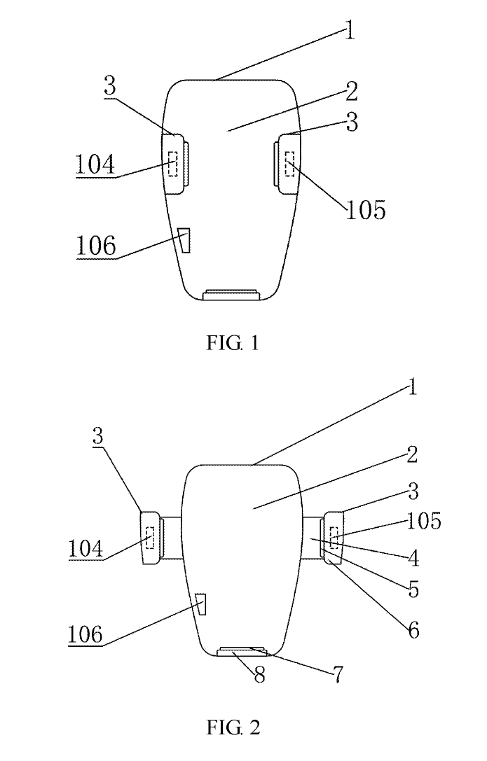

As shown in FIGS. 1 to 2, an infrared intelligent control wireless charging bracket includes a housing 1, the housing 1 is provided with a front panel 2 and a rear panel (not shown in the figures). The inside of the housing 1 is provided with a cavity. Each side of the upper end of the housing 1 is provided with a clamping arm 3 for clamping a mobile phone. The left clamping arm 3 is provided with an infrared emitting module 104, and the right clamping arm 3 is provided with an infrared receiving module 105 at the corresponding position thereon. The infrared emitting module 104 and the infrared receiving module 105 may be interchanged as needed. A touch switch 106 is disposed on the lower left side of the front panel 2 of the housing 1. The lower end of the housing 1 is provided with a supporting member 8 for supporting the mobile phone. A second baffle plate 7 is provided on the upper portion of the supporting member 8. A gap 91 is provided between the second baffle plate 7 and the front panel 2, and the gap 91 may be configured to place the mobile phone. The front panel 2 is a planar structure.

The clamping arm 3 includes a bottom plate 4 and a block 6 connected to the end of the bottom plate 4 away from the housing 1. The inner side of the block 6 is provided with a first baffle plate 5. A gap 92 is provided between the first baffle plate 5 and the bottom plate 4, and the gap 92 may be configured to place the mobile phone. The other end of the bottom plate 4 is located in the cavity of the housing 1, and is connected with a compression spring or an elastic member, so that the clamping arm 3 can clamp the mobile phone when retracting.

Specifically, the infrared emitting module 104 is mounted inside the block 6 of the left clamping arm 3. The inside of the block 6 is provided with an open hole. The open hole is located to allow the infrared light emitted from the infrared emitting module 104 to be received by the infrared receiving module 105. In some embodiments, the infrared receiving module 105 is mounted inside the block 6 of the right clamping arm 3, and accordingly the inside of the block 6 is provided with an opening. The opening is located corresponding to the above open hole.

The housing 1 is further provided with a clamping mechanism module 102, a wireless charging module 101, and a main controller 103 in the cavity thereof.

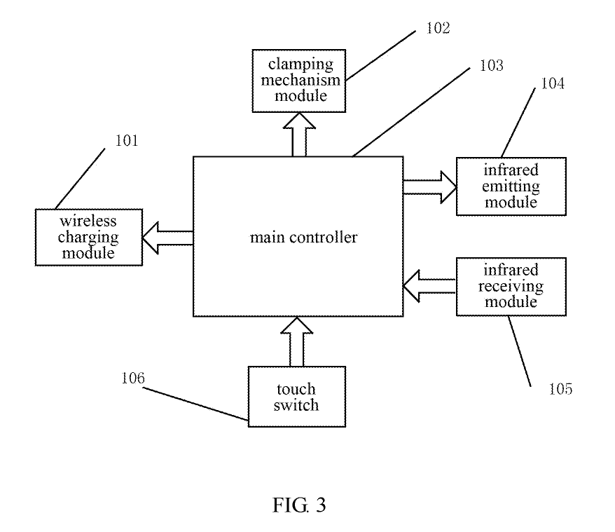

As show in FIG. 3, the main controller 103 is electrically connected with the clamping mechanism module 102, the wireless charging module 101, the infrared emitting module 104, the infrared receiving module 105 and the touch switch 106, respectively.

The clamping mechanism module 102 is configured to control the opening and the retraction of the clamping arm 3.

The wireless charging module 101 is configured to charge the mobile phone.

The main controller 103 is configured to control and manage the whole system.

The infrared emitting module 104 is configured to emit infrared signal, and the infrared receiving module 105 is configured to receive the infrared signal emitted from the infrared emitting module 104. The infrared emitting module 104 and the infrared receiving module 105 cooperate with each other.

The touch switch 106 is configured to control the opening and the retraction of the clamping arms 3 via the clamping mechanism module 102.

Specifically, the clamping mechanism module 102, the wireless charging module 101 and the main controller 103 may be disposed on one circuit board or separately on two circuit boards, and fixed in the cavity of the housing 1.

Specifically, the touch switch 106 is fixed on the lower left portion of the front panel 2, and works by the touch of a human finger.

Specifically, the clamping arms 3 are open in a standby status. The blocks 6 on both sides of the housing 1 are provided with the infrared emitting module 104 and the infrared receiving module 105 respectively. When the mobile phone is placed on the front panel 2 of the housing 1 for charging, the infrared receiving module 105 fails to receive the infrared signal emitted from the infrared emitting module 104, because the mobile phone acts as an obstacle to block the infrared signal, interfering with the infrared transmission. Then the infrared receiving module 105 sends a signal to the main controller 103. When receiving the signal, the main controller 103 sends an instruction to the clamping mechanism module 102. The clamping mechanism module 102 controls the clamping arms 3 to retract and clamp the mobile phone. At the same time, the mobile phone is charged.

Specifically, if user wants to take out the mobile phone, the user touches the touch switch 106 slightly. Then the main controller 103 receives the signal and sends the instruction to the clamping mechanism module 102. The clamping arms 3 are open under the control of the clamping mechanism module 102. The clamping arms 3 return to the standby status after the user takes out the mobile phone.

Specifically, the present disclosure further includes a fixing device for supporting and fixing the housing. The fixing device includes a suction cup assembly for fixing the device, and a connection assembly disposed on the suction cup assembly for connecting with the housing. The connection assembly is fixed on the outer side of the rear panel of the housing.

The foregoing description merely portrays some illustrative embodiments in accordance with the disclosure and therefore is not intended to limit the patentable scope of the disclosure. Any equivalent structure or flow transformations that are made taking advantage of the specification and accompanying drawings of the disclosure and any direct or indirect applications thereof in other related technical fields shall all fall in the scope of protection of the disclosure.

What is claimed is:

1. An infrared intelligent control wireless charging bracket, wherein, the bracket comprises a housing, the housing is defined with a front panel and a rear panel, the inside of the housing defines a cavity, each side of the upper end of the housing is defined with a clamping arm for clamping a mobile phone, one clamping arm is defined with an infrared emitting module, the other clamping arm is defined with an infrared receiving module at a corresponding position thereon, the lower end of the housing is defined with a supporting member for supporting the mobile phone, a second baffle plate is defined on the upper portion of the supporting member, a gap is defined between the second baffle plate and the front panel, and the gap is configured to place the mobile phone; the front panel is a planar structure; a touch switch is defined on the lower left side of the front panel of the housing; the cavity of the housing is defined with a clamping mechanism module, a wireless charging module, and a main controller, the main controller is electrically connected with the clamping mechanism module, the wireless charging module, the infrared emitting module, the infrared receiving module and the touch switch, respectively.

2. The infrared intelligent control wireless charging bracket of claim 1, wherein, the clamping arm comprises a bottom plate and a block connected to the end of the bottom plate away from the housing, the inner side of the block is defined with a first baffle plate, a gap is defined between the first baffle plate and the bottom plate, and the gap is configured to place the mobile phone, the other end of the bottom plate is located in the cavity of the housing, and is connected with a compression spring or an elastic member.

3. The infrared intelligent control wireless charging bracket of claim 1, wherein, the clamping mechanism module is configured to control opening and retraction of the clamping arm.

4. The infrared intelligent control wireless charging bracket of claim 1, wherein, the main controller is configured to control and manage the whole system.

5. The infrared intelligent control wireless charging bracket of claim 1, wherein, the infrared emitting module is configured to emit infrared signal, the infrared receiving module is configured to receive the infrared signal emitted by the infrared emitting module, the infrared emitting module and the infrared receiving module cooperate with each other.
